(19) United States
(12) Patent Application Publication
(10) Pub. No.: US 2004/0064565 A1
(43) Pub. Date: Apr. 1, 2004

(54) Obtaining location information using a rejection model

(75) Inventors: Virinder M. Batra, Chapel Hill, NC (US); Valerie M. Bennett, Macon, NC (US); Larry A. Brocious, Apalachin, NY (US); Andrew N. Capella, Cary, NC (US); Stephen V. Feustel, Endwell, NY (US); Peter R. Gamble, Raleigh, NC (US); Joseph M. Gdaniec, Vestal, NY (US); James P. Hennessy, Endicott, NY (US); Michael J. Howland, Endicott, NY (US)

Correspondence Address: Gerald R. Woods, IBM Corporation T81/503, PO Box 12195, Research Triangle Park, NC, 27709, US

(73) Assignee: International Business Machines Corporation, Armonk, NY

(21) Appl. No.: 10/068,362

(22) Filed: Feb. 6, 2002

(51) Int. Cl. G06F 15/16

(52) U.S. Cl. 709/228

(57) ABSTRACT

A method of requesting location-based services using a rejection model. Responsive to receiving from a pervasive device a network request for location-based processing, the received network request can be stored prior to being forwarded to a selected location-based application. A rejection response to the forwarded network request can be received subsequently and a request for required location information can be identified in the rejection response. The required location information can be identified within the stored network request and a specific network request can be formulated with the required location information. Finally, the specific network request can be forwarded to the selected location-based application. The selected location-based application, in turn, can perform the requested location-based processing using the required location information provided in the specific network response.

### BACKGROUND OF THE INVENTION

1. Statement of the Technical Field

The present invention relates to the field of pervasive computing and more particularly to processing requests for location information in a pervasive computing system.

2. Description of the Related Art

Personal computers no longer are the most common vehicle through which users connect to data communications networks like the Internet. Now that computing can be viewed as being truly everywhere, computer scientists and information technologists have begun to rethink those services that can be provided to meet the needs of mobile computing users. In consequence, the study of pervasive computing has resulted in substantial innovation in the field of network connectivity. “Pervasive computing” has been defined as referring to any non-constrained computing device not physically tethered to a data communications network. Thus, pervasive computing devices refer not only to computers wirelessly linked to networks, but also to handheld computing devices, wearable systems, embedded computing systems and the like.

In the case of pervasive computing devices, mobile users often prefer that the data reflects the location of the pervasive computing device. Notably, while in conventional telephony, it would be unusual to investigate the location of the computing device as phone numbers are linked to a static, geographic location place, in mobile computing, the phone number associated with a pervasive device bears no relation to the physical location of the pervasive device.

Location-based services allow mobile users of pervasive devices and those who communicate with mobile users of pervasive devices to have some knowledge of the geographic proximity of the mobile users. From the perspective of the mobile user, weather forecasts can be requested and provided based upon the location of the mobile user. Likewise, local services such as restrooms or restaurants which are proximate to the pervasive device can be identified based upon the location of the pervasive device. Advantageously, using location-based services it is unnecessary for mobile users first to manually specify ZIP codes or other location identifiers. Rather, the location of the pervasive device can be determined from the pervasive device, itself.

Location-based services typically are deployed in a wireless network in which wireless clients can include cellular telephones, personal digital assistants, paging devices, on-board embedded computing devices and the like. Location finding equipment also can be included within the wireless network and can include satellite based locators, radio-frequency locators and other location detection devices. Network requests from the wireless clients can be forwarded to application servers as can the location data provided by the location finding equipment. The location data can be specified using the well-known Geography Markup Language (GML) and can be selectably forwarded to location-based applications, for instance within the headers of the network requests. Notably, not only can absolute positioning data be provided, but intentionally less certain data can be provided based upon “uncertainty attributes” well-known in the art.

Based upon the location data, the location-based application can provide any number of location-based services, including providing a textual, audible or visual representation of the mobile user's location, or services proximately available to the mobile user. When combined with mobile user preference and profile information, location-based services can drive mobile commerce—the revenue engine of the wireless market. Thus, a bevy of location-based services have been deployed to the Internet, each service having implemented one or more location-based applications.

Presently, the configuration of a location-based services system can involve complexity and cost. In particular, location based applications participate in a registration process as a pre-requisite for requesting location-based information. The configuration and management of the registration process, however, can result in unwanted administrative costs. Also, as a registration process is required to interact with a location-based services provider, only statically determined location-based information can be requested. Finally, present configurations provide fixed groupings of location-based information regardless of the specific location-based information requested. Thus, presently the operation of a conventional location-based services system can result in operational and administrative inefficiencies.

### SUMMARY OF THE INVENTION

The present invention is a rejection model technique for requesting location services or data which overcomes the deficiencies of the prior art. Specifically, in accordance with the present invention, location based applications need not participate in a registration process as a pre-requisite for requesting location-based information. Also, as a registration process is not required to interact with a location-based services provider, dynamically determined location-based information can be requested. Finally, location-based applications need only process that location information which is required to service the request. Thus, in the present invention, the complexity and cost associated with the operation of a conventional location-based services system can be avoided as can the associated operational and administrative inefficiencies.

A method of requesting location-based services can include several steps. First, responsive to receiving from a pervasive device a network request for location-based processing, the network request can be stored prior to being forwarded to a selected location-based application. A rejection response to the forwarded network request can be received subsequently and a request for required location information can be identified in the rejection response. In one aspect of the invention, the requests can be hypertext transfer protocol (HTTP) requests and the rejection response can be a class 4xx HTTP (client error) rejection response.

In any case, the request for required location information can be located within the rejection response. Subsequently, the request can be identified within the rejection response and the required location information can be determined from the stored network request. A specific network request can be formulated with the required location information. Finally, the specific network request can be returned to the selected location-based application. The selected location-based application, in turn, can perform the requested location-based processing using the required location information provided in the specific network response.

In an alternative aspect of the invention, the method can further include caching the augmented network requests in a cache. In that regard, the steps of storing and forwarding the received network request can include determining whether a valid augmented network request associated with the received network request can be located within the cache. If a valid augmented network request can be located within 1id the cache, the valid augmented network request can be forwarded to the selected location based application. In contrast, if a valid augmented network request cannot be located within the cache, the received network request can be stored and subsequently forwarded to the selected location-based application.

Notably, a pattern of received network requests can be recognized which result in a particular rejection response. In that case, a particular formulated augmented network request can be associated with the recognized pattern. For instance, a pattern of received network requests can be recognized which always result in a rejection response containing a request for particular location information. Alternatively, a pattern of received network requests can be recognized which result in a rejection response for which the required location information cannot be provided to the selected location based application as requested in the rejection response.

In either case, a particular formulated augmented network request can be associated with the recognized pattern. Specifically, in the case where the pattern always results in a request for location information which cannot be provided, the particular formulated augmented network request can indicate that the required location information cannot be provided to the selected location based application. In both cases, however, the particular formulated augmented network request can be stored in the cache according to the association.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a schematic illustration of a pervasive computing system configured to perform a rejection model technique for providing specifically requested location information to requesting clients; and,

FIG. 2 is a timing diagram illustrating a method for obtaining specifically requested location information in the pervasive computing system of FIG. 1.

### DETAILED DESCRIPTION OF THE PREFERRED EMBODIMENTS

The present invention is a method of obtaining specifically requested location-based information using a rejection response model. In particular, in the present invention an intermediate location service can receive augmented requests for location-based information from requesting pervasive devices. Upon receipt, location information relating to each augmented request can be temporarily stored. Subsequently, the augmented requests can be forwarded to one or more location-based applications which can determine what specific location information will be required to service the requests.

Significantly, when the required location information has been determined, the location-based application service can specify the required location information in a rejection response. Rejection responses are well-known in the art and include by way of example, class 4xx HTTP rejection responses defined in R. Fielding et al., RFC 2616 Hypertext Transfer Protocol—HTTP/1.1, at 10.4 (June 1999). Upon receipt of the rejection response, the intermediate location service can obtain the required location information from location information stored in association with the augmented request giving rise to the rejection response. Once obtained, the required location information can be added to the original request and the augmented request forwarded to the location-based application which can service the augmented request. Finally, the location-based application can return the resulting response to the requesting client.

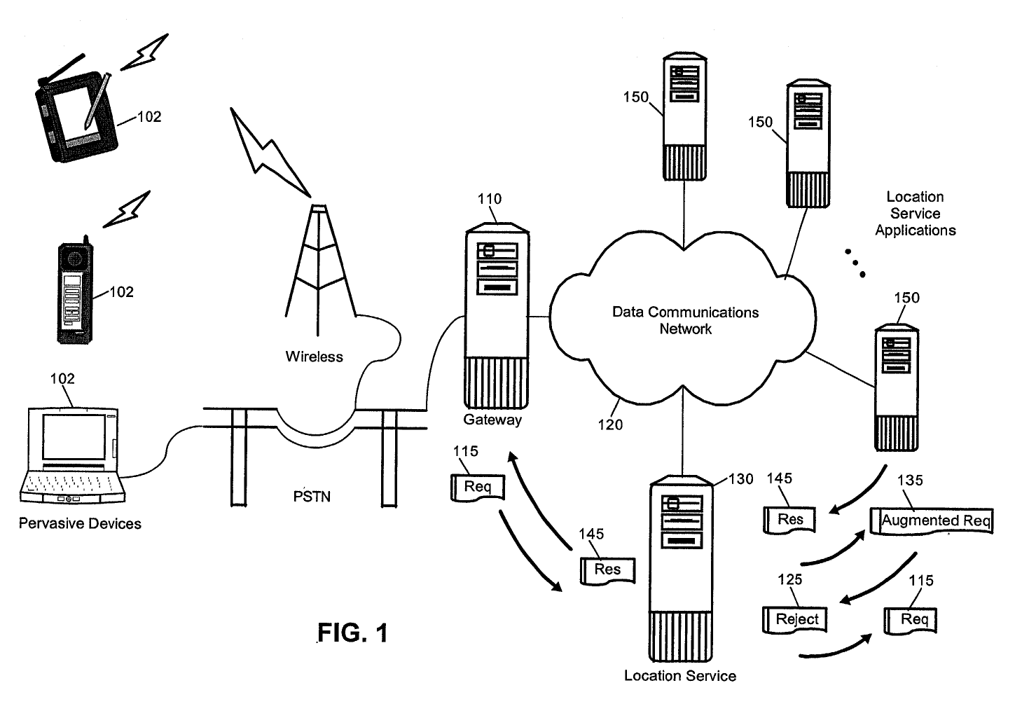

FIG. 1 is a schematic illustration of an integrated network of wireless and wireline pervasive computing devices 102, each communicatively linked to a location service 130 through which location-based services can be provided. In particular, the pervasive computing devices can transmit network requests 115 for specific location-based data or services to the location service 130 via a communications gateway 110. The network requests 115 can be conventional HTTP requests, although the invention is not limited in regard to the particular mode of network communication. Each network request 115 can include within its header, a uniformly formatted request for location-based services or data. In one aspect of the invention, the request for location-based services can be formatted according to GML.

Upon receipt of the network request 115, the location service 130 can parse the header of the network request 115 for a uniformly formatted request for location-based services or data. Once identified within the header, the uniformly formatted request can be temporarily stored in the location service 130. Subsequently, the network request 115 can be returned to a particular location-based application 150 as different location-based service applications 150 can provide different location-based services or data.

Notably, inasmuch as the network request 115 can be specific yet the location-based service application 150 can lack a pre-configured response, the location-based application 150 can determine from the network request 115 what location information will be required for the location-based application 150 to process the request for the location-based service or data. Unlike conventional location-based systems, however, the location-based application 150 can encapsulate the request for required location information within a rejection response 125. For example, the location-based application 150 can encapsulate the request for required location information in a class 4xx HTTP response (client error).

Upon receipt of the rejection response 125, the location service 130 can identify within the rejection response 125 the request for required location information. Based upon the identified required location information, the location service can formulate a augmented request 135 using the location information which had previously been stored upon receipt of the network request 115. Subsequently, the location service 130 can forward the augmented request 135 to the location-based application 150. Upon receipt, the location-based application 150, having the requisite location information, can process the request for location-based services or data.

When the location-based application 150 has completed processing the augmented request 135, a response 145 to the augmented request 135 can be formulated which encapsulates either the requested location-based data or the results from the requested location-based service. In any case, the location-based application 150 can return the response 145 to the requesting client 102 either directly through the gateway 110, or via the location service 130 and the gateway 110. Advantageously, where the location service 130 relays the response 145 to the requesting client 102, a response cache can be maintained in the location service 130.

In that regard, the location service 130 can recognize within received rejection responses 125 patterns of requests for required location information stemming from particular ones of the location-based applications 150. Having recognized a pattern, the location service 130 can automatically provide the requested location information to the location-based application 150 without first undertaking the rejection response process. Notably, a pattern of requests for required location information can be determined where the location information has been requested in a rejection response 125 set forth in response to a series of successive requests 115 or where the location information has been requested N times in response to M successive requests 115.

Additionally, the location service 130 can detect a pattern of rejection responses 125 in which the requested location information contained therein cannot be provided by the location service 130. Specifically, in some cases, despite a request for required location information, the location service 130 will not be able to locate and include the required location information in an augmented request 135. Rather, in those cases a “not able to provide location information” message will be returned to the requesting client 102.

Importantly, the location service 130 can detect a pattern of rejection responses 125 for which the required location information cannot be provided. Once the pattern has been identified, subsequent requests 115 conforming to the pattern can be augmented. Specifically, the subsequent conforming requests 115 can be augmented to include an identifier indicating that the location based application 150 should assume that the location service 130 cannot provide the required location information that otherwise would be included in a rejection response 125. Rather, the location based application can process the request 115 using it “not able to provide location information” path.

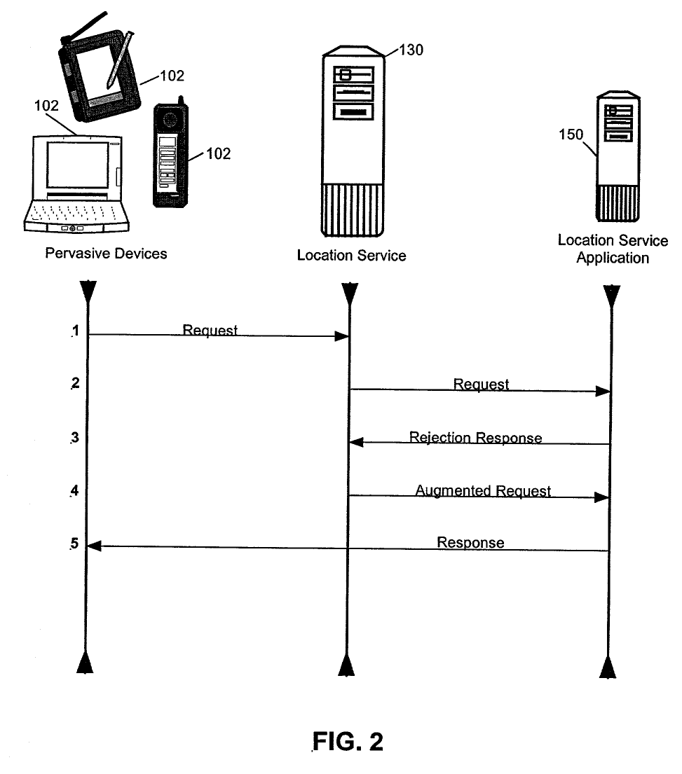

FIG. 2 is a timing diagram illustrating a method for obtaining specifically requested location information in the pervasive computing system of FIG. 1. Beginning in step 1, a pervasive client 102 can request location based content in a network request forwarded to the location service 130. Upon receipt of the network request, the location service 130 can identify within the network request associated location information and subsequently can store the identified location information.

In step 2, the network request can be forwarded to a suitable location-based application 150. The location-based application 150 can receive the network request and can determine therefrom what location information will be required to properly service the network request. In step 3, the required location information can be encapsulated in a rejection response and returned to the location service 130. In step 4, the location service 130 can determine from the stored location information that information which had been specified by location-based application 150 in the rejection response. Subsequently, the required location information can be added to the original request and the augmented request can then be returned to the location-based application 150. Finally, in step 5, the location-based application 150 can process the specific network request and the result can be returned to the requesting client 102.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method of requesting location-based services comprising the steps of:
responsive to receiving a network request for location-based processing from a pervasive device, storing said received network request and forwarding said received network request to a selected location-based application;
receiving a rejection response to said forwarded network request and identifying in said rejection response a request for required location information; and,
locating said required location information from within said stored network request, formulating an augmented network request with said required location information, and forwarding said augmented network request to said selected location-based application, said selected location-based application performing said location-based processing using said required location information provided in said augmented network response.

2. The method of claim 1, wherein said network requests are hypertext transfer protocol (HTTP) requests and said rejection response is a class 4xx HTTP rejection response.

3. The method of claim 1, further comprising, the steps of:
caching said augmented network requests in a cache.

4. The method of claim 3, wherein said steps of storing and forwarding said received network request comprises the steps of:
determining whether a valid augmented network request associated with said received network request can be located within said cache; and,
if said valid augmented network request can be located within said cache, forwarding said valid augmented network request to said selected location based application; and,
if a valid augmented network request cannot be located within said cache, storing said received network request and forwarding said received network request to said selected location-based application.

5. The method of claim 4, further comprising the steps of:
recognizing a pattern of received network requests which result in a particular rejection response;
associating a particular formulated augmented network request with said recognized pattern; and,
storing said particular formulated augmented network request in said cache according to said association.

6. The method of claim 4, further comprising the steps of:
recognizing a pattern of received network requests which result in a rejection response for which said required location information cannot be provided to said selected location based application as requested in said rejection response;
associating a particular formulated augmented network request with said recognized pattern, said particular formulated augmented network request indicating that said required location information cannot be provided to said selected location based application; and,
storing said particular formulated augmented network request in said cache according to said association.

7. A machine readable storage having stored thereon a computer program for requesting location-based services, the computer program comprising a routine set of instructions for causing the machine to perform the steps of:
responsive to receiving a network request for location-based processing from a pervasive device, storing said received network request and forwarding said received network request to a selected location-based application;
receiving a rejection response to said forwarded network request and identifying in said rejection response a request for required location information; and,
locating said required location information from within said stored network request, formulating an augmented network request with said required location information, and forwarding said augmented network request to said selected location-based application, said selected location-based application performing said location-based processing using said required location information provided in said augmented network response.

8. The machine readable storage of claim 7, wherein said network requests are hypertext transfer protocol (HTTP) requests and said rejection response is a class 4xx HTTP rejection response.

9. The machine readable storage of claim 7, further comprising the steps of:
caching said augmented network requests in a cache.

10. The machine readable storage of claim 9, wherein said steps of storing and forwarding said received network request comprises the steps of:
determining whether a valid augmented network request associated with said received network request can be located within said cache; and,
if said valid augmented network request can be located within said cache, forwarding said valid augmented network request to said selected location based application; and,
if a valid augmented network request cannot be located within said cache, storing said received network request and forwarding said received network request to said selected location-based application.

11. The machine readable storage of claim 10, further comprising the steps of:
recognizing a pattern of received network requests which result in a particular rejection response;
associating a particular formulated augmented network request with said recognized pattern; and,
storing said particular formulated augmented network request in said cache according to said association.

12. The machine readable storage of claim 10, further comprising the steps of:
recognizing a pattern of received network requests which result in a rejection response for which said required location information cannot be provided to said selected location based application as requested in said rejection response;
associating a particular formulated augmented network request with said recognized pattern, said particular formulated augmented network request indicating that said required location information cannot be provided to said selected location based application; and,
storing said particular formulated augmented network request in said cache according to said association.
